(19) United States
(12) Patent Application Publication
(10) Pub. No.: US 2008/0149454 A1
(43) Pub. Date: Jun. 26, 2008

(54) Wire form one-way clutch

(75) Inventors: Philip George, Wooster, OH (US); Marion Jack Ince, Mt. Holly, NC (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/001,242

(22) Filed: Dec. 11, 2007

Related U.S. Application Data
(60) Provisional application No. 60/876,715, filed on Dec. 22, 2006.

(51) Int. Cl. F16D 23/00

(52) U.S. Cl. 192/93 C

(57) ABSTRACT

A one-way clutch including first and second races circumferentially disposed about an axis for the clutch, and a blocking element disposed between the races. The first race is arranged for rotational connection to a torque transmitting element in an automotive device, the blocking element is formed from wire and is arranged to rotationally lock the races for relative rotation of the first race in a first rotational direction, and the first race is arranged to rotate independently of the second race for relative rotation in a second rotational direction, opposite the first rotational direction. A circumferential extent of the blocking element in contact with the races is greater than an axial extent of the blocking element in contact with the races. In some aspects, the blocking element is arranged to attenuate energy associated with the rotational locking.

### CROSS-REFERENCE TO RELATED APPLICATIONS

This application claims the benefit under 35 U.S.C. §119(e) of U.S. Provisional Application No. 60/876,715 filed on Dec. 22, 2006 which application is incorporated herein by reference.

### FIELD OF THE INVENTION

The invention relates to improvements in apparatus for transmitting force between a rotary driving unit (such as the engine of a motor vehicle) and a rotary driven unit (such as the variable-speed transmission in the motor vehicle). In particular, the invention relates to a radial one-way clutch. Even more specifically, the invention relates to a radial one-way clutch for a stator in a torque converter using wire form as the engagement means.

### BACKGROUND OF THE INVENTION

FIG. 1 illustrates a general block diagram showing the relationship of the engine 7, torque converter 10, transmission 8, and differential/axle assembly 9 in a typical vehicle. It is well known that a torque converter is used to transmit torque from an engine to a transmission of a motor vehicle.

The three main components of the torque converter are the pump 37, turbine 38, and stator 39. The torque converter becomes a sealed chamber when the pump is welded to cover 11. The cover is connected to flexplate 41 which is, in turn, bolted to crankshaft 42 of engine 7. The cover can be connected to the flexplate using lugs or studs welded to the cover. The welded connection between the pump and cover transmits engine torque to the pump. Therefore, the pump always rotates at engine speed. The function of the pump is to use this rotational motion to propel the fluid radially outward and axially towards the turbine. Therefore, the pump is a centrifugal pump propelling fluid from a small radial inlet to a large radial outlet, increasing the energy in the fluid. Pressure to engage transmission clutches and the torque converter clutch is supplied by an additional pump in the transmission that is driven by the pump hub.

In torque converter 10 a fluid circuit is created by the pump (sometimes called an impeller), the turbine, and the stator (sometimes called a reactor). The fluid circuit allows the engine to continue rotating when the vehicle is stopped, and accelerate the vehicle when desired by a driver. The torque converter supplements engine torque through torque ratio, similar to a gear reduction. Torque ratio is the ratio of output torque to input torque. Torque ratio is highest at low or no turbine rotational speed (also called stall). Stall torque ratios are typically within a range of 1.8-2.2. This means that the output torque of the torque converter is 1.8-2.2 times greater than the input torque. Output speed, however, is much lower than input speed, because the turbine is connected to the output and it is not rotating, but the input is rotating at engine speed.

Turbine 38 uses the fluid energy it receives from pump 37 to propel the vehicle. Turbine shell 22 is connected to turbine hub 19. Turbine hub 19 uses a spline connection to transmit turbine torque to transmission input shaft 43. The input shaft is connected to the wheels of the vehicle through gears and shafts in transmission 8 and axle differential 9. The force of the fluid impacting the turbine blades is output from the turbine as torque. Axial thrust bearings 31 support the components from axial forces imparted by the fluid. When output torque is sufficient to overcome the inertia of the vehicle at rest, the vehicle begins to move.

After the fluid energy is converted to torque by the turbine, there is still some energy left in the fluid. The fluid exiting from small radial outlet 44 would ordinarily enter the pump in such a manner as to oppose the rotation of the pump. Stator 39 is used to redirect the fluid to help accelerate the pump, thereby increasing torque ratio. Stator 39 is connected to stator shaft 45 through one-way clutch 46. The stator shaft is connected to transmission housing 47 and does not rotate. One-way clutch 46 prevents stator 39 from rotating at low speed ratios (where the pump is spinning faster than the turbine). Fluid entering stator 39 from turbine outlet 44 is turned by stator blades 48 to enter pump 37 in the direction of rotation.

The blade inlet and exit angles, the pump and turbine shell shapes, and the overall diameter of the torque converter influence its performance. Design parameters include the torque ratio, efficiency, and ability of the torque converter to absorb engine torque without allowing the engine to “run away.” This occurs if the torque converter is too small and the pump can't slow the engine.

At low speed ratios, the torque converter works well to allow the engine to rotate while the vehicle is stationary, and to supplement engine torque for increased performance. At speed ratios less than 1, the torque converter is less than 100% efficient. The torque ratio of the torque converter gradually reduces from a high of about 1.8 to 2.2, to a torque ratio of about 1 as the turbine rotational speed approaches the pump rotational speed. The speed ratio when the torque ratio reaches 1 is called the coupling point. At this point, the fluid entering the stator no longer needs redirected, and the one way clutch in the stator allows it to rotate in the same direction as the pump and turbine. Because the stator is not redirecting the fluid, torque output from the torque converter is the same as torque input. The entire fluid circuit will rotate as a unit.

Peak torque converter efficiency is limited to 92-93% based on losses in the fluid. Therefore torque converter clutch 49 is employed to mechanically connect the torque converter input to the output, improving efficiency to 100%. Clutch piston plate 17 is hydraulically applied when commanded by the transmission controller. Piston plate 17 is sealed to turbine hub 19 at its inner diameter by o-ring 18 and to cover 11 at its outer diameter by friction material ring 51. These seals create a pressure chamber and force piston plate 17 into engagement with cover 11. This mechanical connection bypasses the torque converter fluid circuit.

The mechanical connection of torque converter clutch 49 transmits many more engine torsional fluctuations to the drivetrain. As the drivetrain is basically a spring-mass system, torsional fluctuations from the engine can excite natural frequencies of the system. A damper is employed to shift the drivetrain natural frequencies out of the driving range. The damper includes springs 15 in series with engine 7 and transmission 8 to lower the effective spring rate of the system, thereby lowering the natural frequency.

Torque converter clutch 49 generally comprises four components: piston plate 17, cover plates 12 and 16, springs 15, and flange 13. Cover plates 12 and 16 transmit torque from piston plate 17 to compression springs 15. Cover plate wings 52 are formed around springs 15 for axial retention. Torque from piston plate 17 is transmitted to cover plates 12 and 16 through a riveted connection. Cover plates 12 and 16 impart torque to compression springs 15 by contact with an edge of a spring window. Both cover plates work in combination to support the spring on both sides of the spring center axis. Spring force is transmitted to flange 13 by contact with a flange spring window edge. Sometimes the flange also has a rotational tab or slot which engages a portion of the cover plate to prevent over-compression of the springs during high torque events. Torque from flange 13 is transmitted to turbine hub 19 and into transmission input shaft 43.

Energy absorption can be accomplished through friction, sometimes called hysteresis, if desired. Hysteresis includes friction from windup and unwinding of the damper plates, so it is twice the actual friction torque. The hysteresis package generally consists of diaphragm (or Belleville) spring 14 which is placed between flange 13 and one of cover plates 16 to urge flange 13 into contact with the other cover plate 12. By controlling the amount of force exerted by diaphragm spring 14, the amount of friction torque can also be controlled. Typical hysteresis values are in the range of 10-30 Nm.

Modern automotive design creates constant pressure to reduce the size of torque converters, in particular, the axial length of a torque converter. As well, the increasingly competitive nature of the automotive market demands that the complexity and cost of torque converter components be reduced at every opportunity. An intermediary element(s) in a one-way clutch must sustain the torque delivered by the rotating element of the clutch. For example, for a clutch with a rotating member and a fixed member, to sustain the torque, the intermediary element(s) must have a certain amount of surface area in contact with the rotating and fixed members of the clutch. It is known to use roller or sprag clutches for a one-way clutch. The rollers are axially aligned and the relatively small portion of the rollers in contact with the clutch races must be designed to bear the force associated with the operation of the stator, particularly in the locked mode. Unfortunately, to account for the forces, the axial length of the rollers must be made relatively long, increasing the axial width of the clutch. Also, roller and sprag clutches are relatively complex and include a large number of precision elements.

Thus, there is a long-felt need for a one-way clutch for a stator in a torque converter having a reduced axial length and using more cost-effective components and processes.

### BRIEF SUMMARY OF THE INVENTION

The present invention broadly comprises a one-way clutch including a first race circumferentially disposed about an axis for the clutch; a second race circumferentially disposed about the axis; and a blocking element disposed between the races. The first race is arranged for rotational connection to a torque transmitting element in an automotive device, the blocking element is formed from wire and is arranged to rotationally lock the first and second races for relative rotation, with respect to the second race, of the first race in a first rotational direction, and the first race is arranged to rotate independently of the second race for rotation, with respect to the second race, in a second rotational direction, opposite the first rotational direction.

A circumferential extent of the blocking element in contact with the first and second races is greater than an axial extent of the blocking element in contact with the first and second races. In some aspects, the blocking element is arranged to attenuate energy associated with the rotational locking. In some aspects, during the locking engagement, the circumferential extent is arranged to increase.

The first or second race includes at least one axial protrusion, the blocking element is arranged to lockingly engage with the at least one protrusion for relative rotation in the first direction, and for relative motion in the second rotational direction, the blocking element is arranged to slidingly engage consecutive protrusions from among the at least one protrusion. In some aspects, the at least one axial protrusion comprises at least one ramp. In some aspects, the at least one axial protrusion is arranged to axially displace the blocking element as part of the sliding engagement. In some aspects, the blocking element is arranged to flex when the blocking element lockingly engages the at least one protrusion, the flexing to dissipate energy associated with the locking engagement.

The first or second race includes at least one recess and the blocking element comprises at least one segment disposed in the at least one recess and rotationally connecting the first or second race and the blocking element. In some aspects, the clutch is arranged for use in a stator of a torque converter.

The present invention also broadly comprises a stator one-way clutch including a hub; an outer element arranged for connection to a blade assembly for the stator; and a blocking element. The blocking element is formed from wire and is arranged to rotationally lock the hub and the outer element for rotation of the outer element in a first rotational direction. A circumferential extent of the blocking element in contact with the hub and the outer element is greater than an axial extent of the blocking element in contact with the hub and the outer element. The hub or outer element includes at least one axial protrusion, the blocking element is arranged to lockingly engage with the at least one protrusion for rotation in the first direction, and for rotation of the outer element in a second rotational direction, opposite the first rotational direction, the blocking element is arranged to slidingly engage consecutive protrusions from among the at least one protrusion. In some aspects, the at least one axial protrusion comprises at least one ramp.

In some aspects, the blocking element is arranged to flex when the blocking element lockingly engages the at least one protrusion to dissipate energy associated with the locking engagement. The hub or outer element includes at least one recess and the blocking element comprises at least one segment disposed in the at least one recess and rotationally connecting the one of the hub and the blocking element.

It is a general object of the present invention to provide a one-way clutch having a reduced axial length.

It is a general object of the present invention to provide a one-way clutch that can be produced economically with stamped parts.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a general block diagram illustration of power flow in a motor vehicle, intended to help explain the relationship and function of a torque converter in the drive train thereof;

FIG. 2 is a cross-sectional view of a prior art torque converter, shown secured to an engine of a motor vehicle;

FIG. 3 is a left view of the torque converter shown in FIG. 2, taken generally along line 3-3 in FIG. 2;

FIG. 4 is a cross-sectional view of the torque converter shown in FIGS. 2 and 3, taken generally along line 4-4 in FIG. 3;

FIG. 5 is a first exploded view of the torque converter shown in FIG. 2, as shown from the perspective of one viewing the exploded torque converter from the left;

FIG. 6 is a second exploded view of the torque converter shown in FIG. 2, as shown from the perspective of one viewing the exploded torque converter from the right;

FIG. 7A is a perspective view of a cylindrical coordinate system demonstrating spatial terminology used in the present application;

FIG. 7B is a perspective view of an object in the cylindrical coordinate system of FIG. 7A demonstrating spatial terminology used in the present application;

FIG. 8 is a front exploded perspective view of a present invention one way clutch;

FIG. 9 is a back exploded perspective view of the present invention clutch shown in FIG. 8;

FIG. 10 is a front perspective view of the one way clutch shown in FIG. 8;

FIG. 11 is a back perspective view of the one way clutch shown in FIG. 8; and,

FIG. 12 is a front view of the outer race and blocking element shown in FIG. 8.

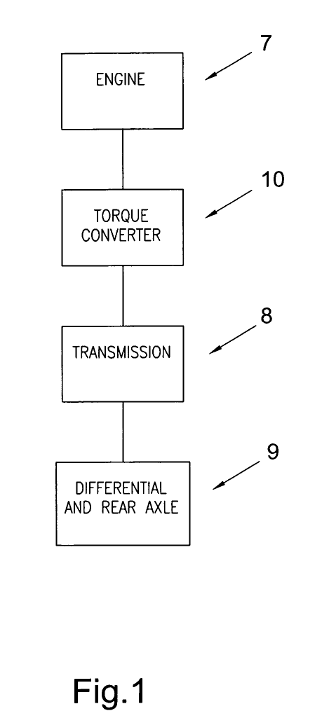

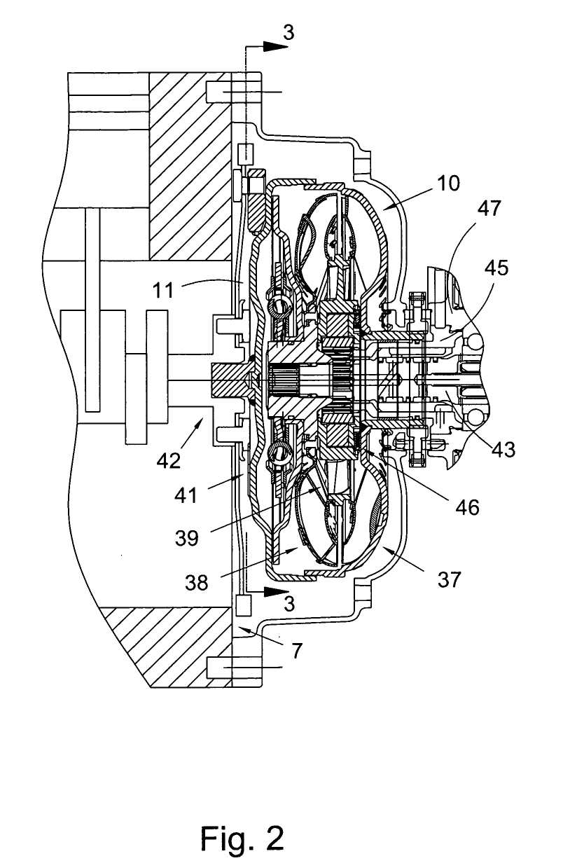

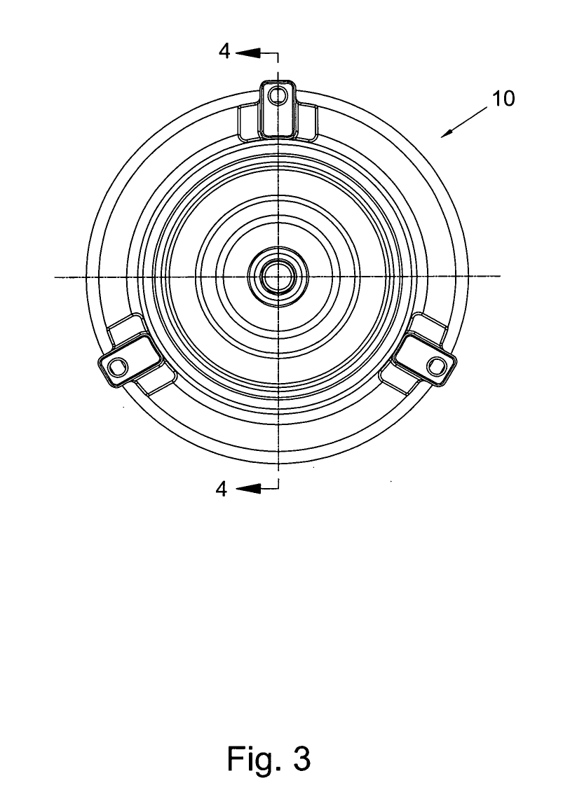

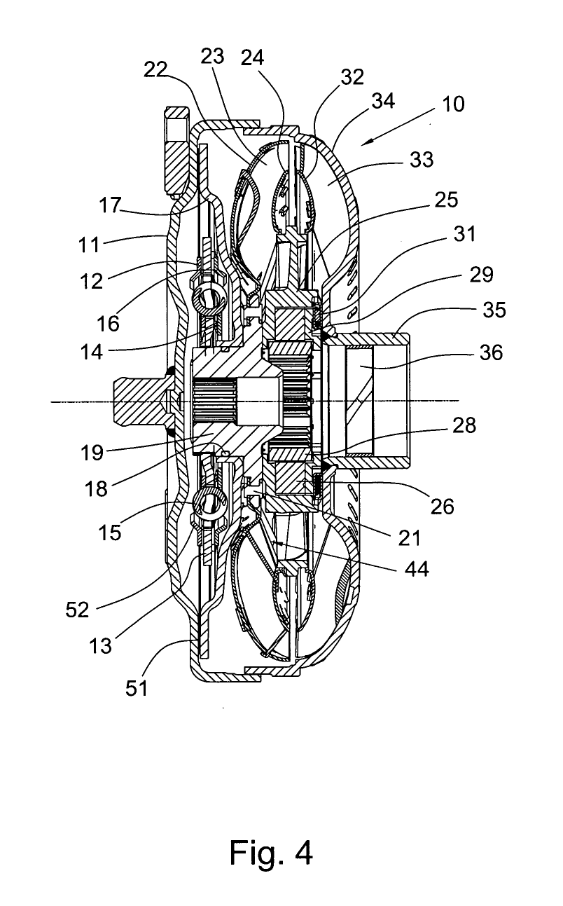

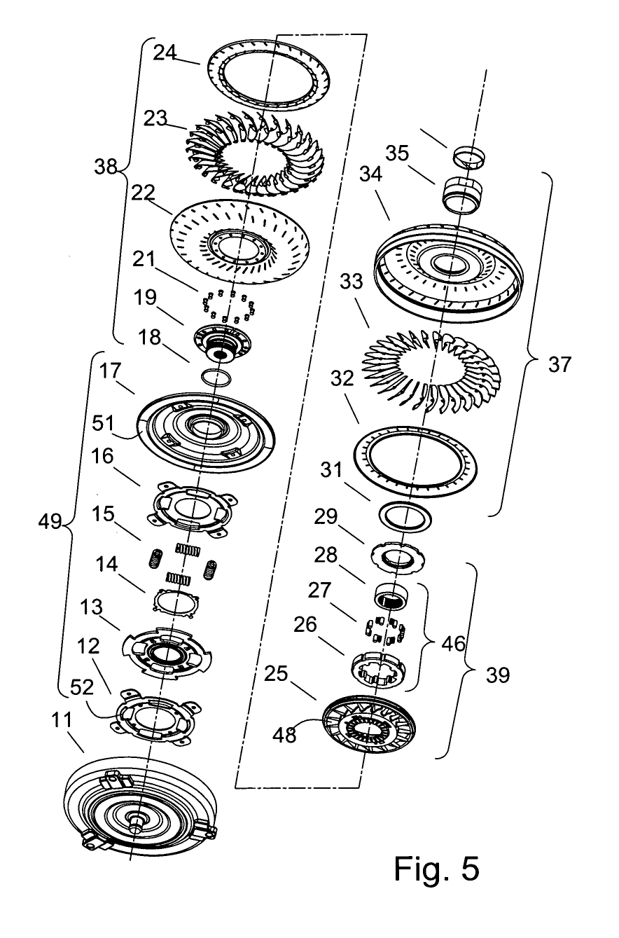

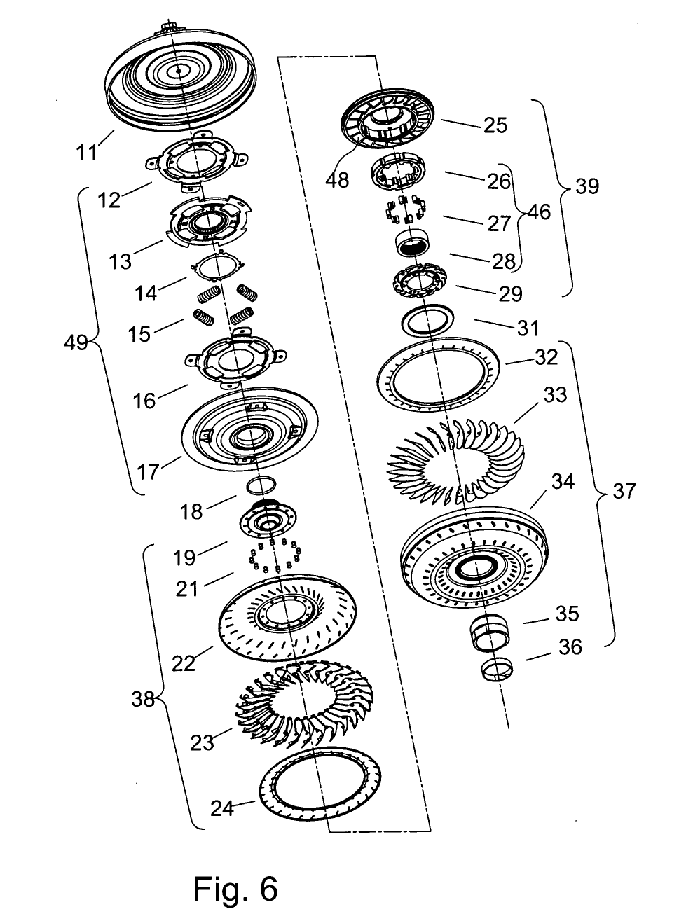

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

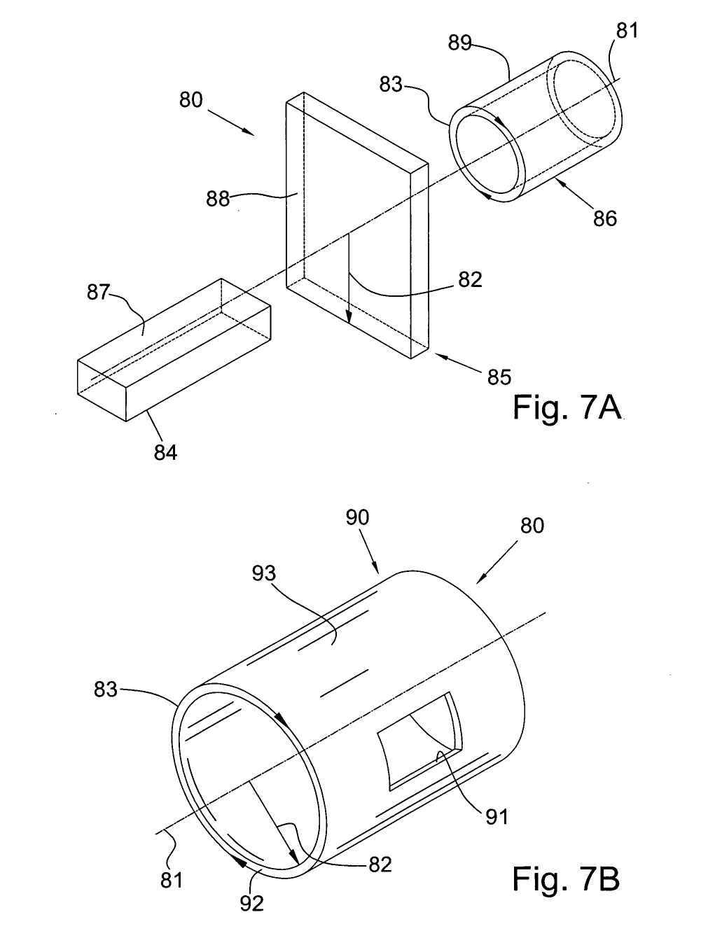

FIG. 7A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), or circumference 83, respectively. The adjectives “axial,” “radial” and “circumferential” refer to orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” refer to an orientation parallel to axis 81, radius 82, or circumference 83, respectively. The adverbs “axially,” “radially,” and “circumferentially” refer to an orientation parallel to respective planes.

FIG. 7B is a perspective view of object 90 in cylindrical coordinate system 80 of FIG. 7A demonstrating spatial terminology used in the present application. Cylindrical object 90 is representative of a cylindrical object in a cylindrical coordinate system and is not intended to limit the present invention is any manner. Object 90 includes axial surface 91, radial surface 92, and circumferential surface 93. Surface 91 is part of an axial plane, surface 92 is part of a radial plane, and surface 93 is part of a circumferential plane.

The terms “lockingly” and “slidingly” refer to relative movement between two objects, where “lockingly” is used to describe a condition in which two objects are engaged with one another to prevent movement relative to one another. “Slidingly” is used to describe a condition is which two objects are engaged with one another, but move with respect to one another.

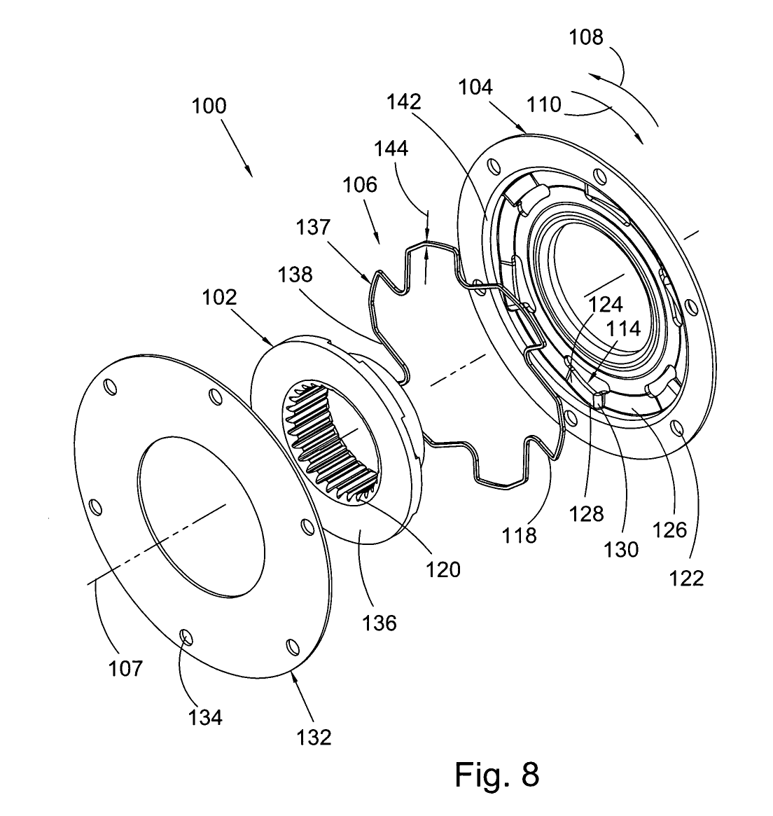

FIG. 8 is a front exploded perspective view of present invention one way clutch 100.

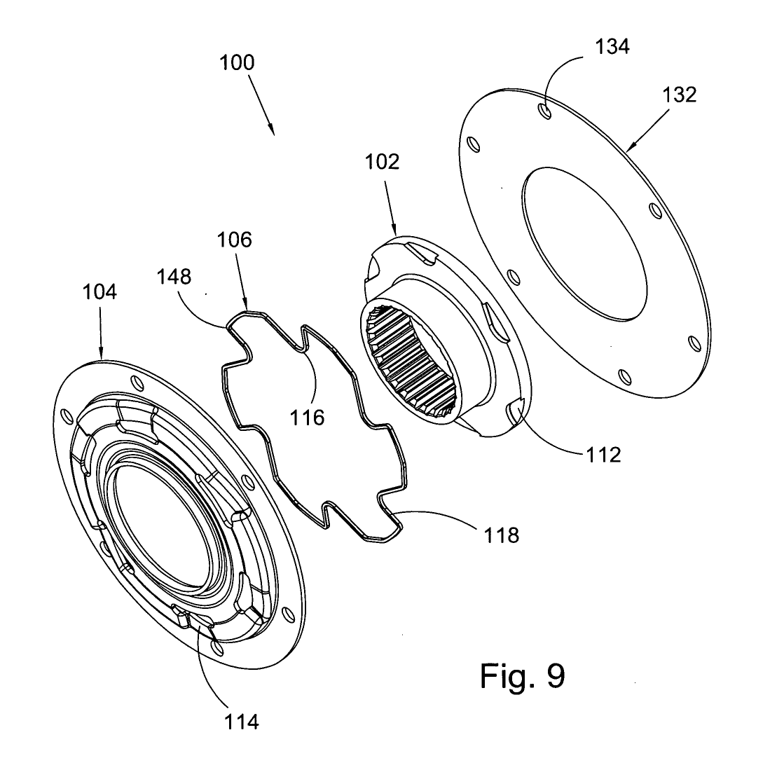

FIG. 9 is a back exploded perspective view of clutch 100 shown in FIG. 8.

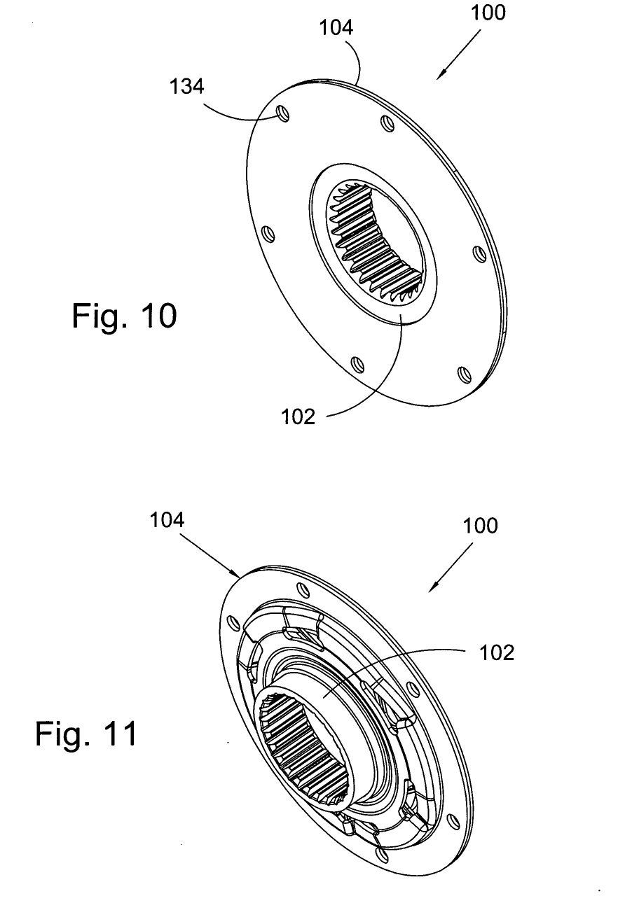

FIG. 10 is a front perspective view of one way clutch 100 shown in FIG. 8.

FIG. 11 is a back perspective view of one way clutch 100 shown in FIG. 8. The following should be viewed in light of FIGS. 8 through 11. One way clutch 100 includes inner race 102, outer race 104, and blocking element 106. Races 102 and 104 are disposed about axis of rotation, or longitudinal axis, 107 for the clutch. One of the races is arranged for rotational connection to a torque transmitting element (not shown) in an automotive device (not shown). In FIG. 8, race 104 is arranged for connection to the torque transmitting element and this configuration is assumed for the discussion that follows unless noted otherwise. The blocking element is formed from wire, or another resilient material having a relatively small cross-section in comparison to length, and is arranged to rotationally lock the races for relative rotation of race 104 in a locking mode direction, for example, direction 108. By rotationally lock, we mean that the races are forced to rotate in unison. The locking can be through a direct connection of the races, or, as shown in the figures, or through an intermediary component, for example, element 106. The relative rotation is with respect to the race not connected to the torque transmitting element, that is, race 102. Race 104 is arranged to rotate independently of race 102 for rotation, with respect to race 102, in an opposing free wheel direction, for example, direction 110. That is, race 104 free wheels for relative rotation in direction 110. Although directions 108 and 110 are shown as counter clockwise and clockwise, respectively, it should be understood that locking and free wheeling in a present invention clutch are not limited to any particular rotational direction. In some aspects, race 102 is a hub and is rotationally fixed. For example, clutch 100 is a stator clutch for a torque converter (not shown) and race 102 is connected to a grounded stator shaft (not shown). However, it should be understood that a present invention clutch is not limited to use with a torque converter stator and that a present convention clutch can be used with other torque transmitting elements in other automotive devices.

For the discussion that follows and for purposes of illustration, race 104 is connected to the torque transmitting device, unless stated otherwise. However, it should be understood that race 102, rather than race 104 can be connected to the torque transmitting device and that the discussion infra is generally applicable to the aspects in which race 102 is connected to the torque transmitting element.

Race 102 includes at least one recess 112 and race 104 includes at least one axial protrusion 114. Blocking element 106 includes at least one segment 116 disposed in respective recesses 112. Segments 116 and recesses 112 rotationally connect race 102 and the blocking element. By rotationally connected, or secured, we mean that the blocking element and the race are connected such that the respective components rotate together, that is, the components are fixed with respect to rotation. Rotationally connecting two components does not necessarily limit relative movement in other directions. For example, it is possible for two components that are rotationally connected to have axial movement with respect to each other via a spline connection. However, it should be understood that rotational connection does not imply that movement in other directions is necessarily present. For example, two components that are rotationally connected can be axially fixed one to the other. The preceding explanation of rotational connection is applicable to the discussions infra.

The blocking element also includes segments 118. For rotation of race 104 in direction 108, segments 118 lockingly engage with protrusions 114 to rotationally lock the races. For rotation of race 104 in direction 110, blocking element 106 slides over the protrusions without lockingly engaging the protrusions. In some aspects, the wire from which the blocking element is formed is sufficiently flexible to flex during the engagement of segments 118 with the protrusions. Advantageously, this flexing absorbs some of the energy associated with the rotational locking, specifically with the engagement of the segments and protrusions to attenuate the energy. For example, the attenuation may reduce or eliminate a vibration or noise associated with the engagement.

It should be understood that clutch 100 is not limited to a rotationally fixed race 102 and a rotatable race 104. In some aspects, race 102 is arranged for connection to a torque transmitting element and race 104 is fixed. In some aspects, both the races are rotatable and the rotation between the torque receiving race and the other race is a relative rotation. For example, to trigger the lock up mode, the race connected to the torque transmitting element rotates more rapidly in the lock up direction than the other race.

Races 102 and 104 can be connected to a torque transmitting element, connected to a torque receiving element, or rotationally fixed using any means known in the art. For example, race 102 can be connected or fixed using splines 120 and race 104 can be connected or fixed using any fasteners (not shown) known in the art and openings 122.

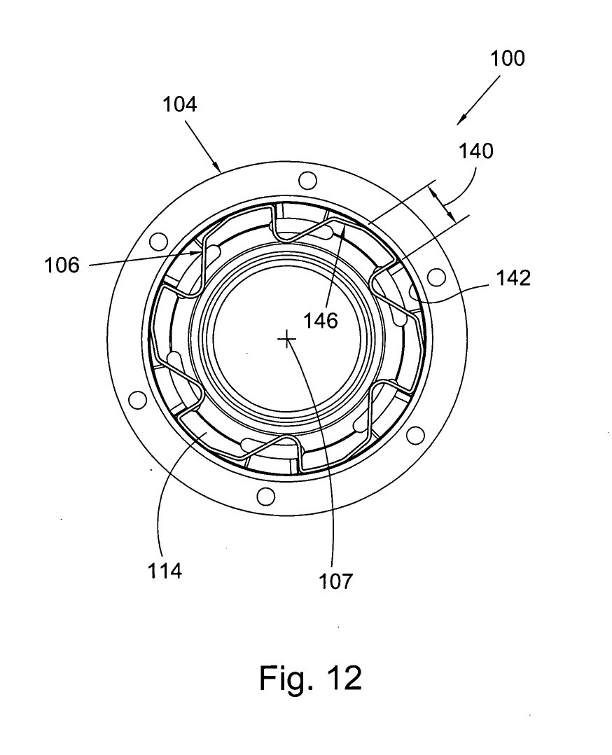

FIG. 12 is a rear view of race 104 and blocking element 106 shown in FIG. 8. The following should be viewed in light of FIGS. 8 through 12. In some aspects, protrusions 114 are ramps. Foot 124 of the ramp coincides with at least portions of surface 126 of race 104 and the ramp increases axially (increases in height with respect to surface 126) to top 128. At top 128, the ramp includes face 130 which forms a steep angle with respect to surface 126. In some aspects, face 130 is substantially orthogonal to surface 126. Segments 118 form a radial angle similar to a radial angle for faces 130, although as described below, the angles may be different to enable flexing of the blocking element during engagement of the faces and segments 118. In some aspects, clutch 100 includes plate 132. Plate 132 connects to race 104 using any means known in the art, for example, fasteners (not shown) and openings 134 and 122. Plate 132 engages surface 136 of race 102 and axially holds race 102 with respect to race 104.

Segments 116 are fixed between the races by the connection of plate 132 and race 104. This fixing of segments 116 operates to keep the blocking element in radial alignment with recesses 112. Starting in the configuration shown in FIG. 10, for a locking mode of clutch 100, race 104 rotates in direction 108, moving the ramps, in particular, faces 130, into contact with segments 118 (race 102 is rotationally fixed). The angle of the faces opposes the further movement of segments 118, for example, in some aspects, the faces are substantially orthogonal to surface 126 and direction 108. Further, the engagement of segments 116 with the races works to keep segments 118 in contact with surface 126. Thus, faces 130 cannot advance past segments 118 and the races are rotationally locked in direction 108. The blocking element is sufficiently flexible to enable axial movement of the blocking element on the more gradual slope presented by the ramp (between the foot and top of the ramp). Thus, clutch 100 can begin a locking mode with segments 118 disposed on the ramps, and as race 104 rotates, the segments slide down the ramps to surface 126 to engage the faces. In locking mode, segments 118 can be thought of as the leading portion of segments 137.

For a free wheel mode, race 104 rotates in direction 110 and segments 138 can be thought of as the leading portion of segments 137. That is, as ramps 114 rotate in direction 110, the ramps first encounter segments 138, rather than segments 118. Thus, segments 138 ride up the ramps, drop to surface 126 at faces 130, without a locking engagement to race 104 and continue to rotate according to the rotation of race 104. Alternately stated, in free wheel mode, segment 138 can slidingly engage with consecutive ramps, or axial protrusions, 114. The flexibility described supra enables the axial flexing of the blocking element needed to ride up the ramps and drop to surface 126.

The circumferential extent of the blocking element in contact with the races is greater than the axial extent of the blocking element in contact with the races. For example, dimension 140 of the blocking element, corresponding to a portion of the blocking element in contact with circumferential surface 142 of race 104 is greater than diameter 144 of the blocking element, which is the axial dimension for the portion of the blocking element in contact with surface 142. Thus, advantageously, during rotational lock up of the races, circumferential dimension 140 is greater than axial dimension 144. Hence, since the configuration of the blocking element increases the circumferential extent of contact with the races, the axial extent of the blocking element is reduced while maintaining the necessary load-bearing capacity for the blocking element. Therefore, the axial extent of clutch 100 is advantageously reduced. Surfaces 126 and 142 also provide stability and axial and radial support for the blocking element.

Returning to the locking mode, in some aspects, the circumferential extent of blocking element 106 in contact with race 104, in particular, surface 142 is arranged to increase as segments 118 engage the faces. For example, when segments 118 are not contacting the faces, segments 146 are not in contact with surface 142. However, as segments 118 engage the faces, the engagement generates a radially outward force on segments 146, driving segments 146 into contact with surface 142. The blocking element resists this movement, and therefore, energy associated with the engagement must be used to drive the segments. Advantageously, the use of this energy attenuates energy that could otherwise manifest as undesirable vibration or noise. Alternately stated, upon locking engagement of blocking element 106 with axial protrusions 114, segments 146 expand radially to both absorb the locking engagement force and to support blocking element 106 along surface 142.

In some aspects (not shown), segments 118 are radially angled so that radially outward most portion 148 of the segments contacts the faces before the remainder of the segments, and as the race continues to move toward the segments, energy from the movement of the races “straightens” the segments so that the segments fully contact the faces. The energy used to straighten the segments attenuates energy that could otherwise manifest as undesirable vibration or noise.

For those aspects in which race 102 is connected to the torque transmitting device, the preceding discussion is applicable, with the reversal of directions (assuming the configuration shown in FIG. 8). Specifically, with the configuration shown, when the race rotates in direction 108 with respect to race 104, race 102 free wheels, and when race 102 rotates in direction 110 with respect to race 104, the races lock.

In some aspects (not shown), the radial configuration of the blocking element and races is reversed. That is, race 104 is rotationally connected to an outer circumference of the blocking element (the analog of the connection of recesses 112 and segments 116), race 102 is formed with protrusions, and an inner circumference of the blocking element is formed with segments to engage the protrusions. In general, the discussion in the description of FIGS. 8 through 14 is applicable to the preceding configuration with appropriate adjustment of rotational directions. For example, in this configuration, either of the races can be connected to the torque transmitting element.

Clutch 100 is shown with six ramps 114 and corresponding segments of the blocking element. However, it should be understood that clutch 100 is not limited to a specific number of ramps. For example, clutch 100 can have more or less than six ramps. The number of ramps used can be determined according to the desired torque capacity of the automotive device using the clutch and manufacturing considerations, for example, considerations concerning a particular fabricating process. It also should be understood that the circumferential orientation of the ramps and the blocking element can be reversed. For example, ramps 114 can be configured to increase in height in direction 110, rather than direction 108.

The wire for blocking element 106 can be any wire known in the art, made of any material known in the art. The wire is not limited to a particular size, cross-section, or set of characteristics, such as resilience or plastic limit. Thus, if a present invention clutch is used in a torque converter stator, the number of ramps formed on the races can be increased, and/or the size or strength of the wire for the blocking element can be increased, as the power of the engine for the vehicle housing the torque converter increases and vise versa. It also should be understood that a present invention clutch is not limited to the exact configuration shown in the figures and that other configurations are within the spirit and scope of the claimed invention.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A one-way clutch comprising:
a first race circumferentially disposed about an axis for said clutch;
a second race circumferentially disposed about said axis; and,
a blocking element disposed between said first and second races, wherein said first race is arranged for rotational connection to a torque transmitting element in an automotive device, wherein said blocking element is formed from wire and is arranged to rotationally lock said first and second races for relative rotation, with respect to said second race, of said first race in a first rotational direction, and wherein said first race is arranged to rotate independently of said second race for rotation, with respect to said second race, in a second rotational direction, opposite said first rotational direction.

2. The one-way clutch of claim 1 wherein said blocking element is arranged to attenuate energy associated with said rotational locking.

3. The one-way clutch of claim 1 wherein a circumferential extent of said blocking element in contact with said first and second races is greater than an axial extent of said blocking element in contact with said first and second races.

4. The one-way clutch of claim 3 wherein during said locking engagement, said circumferential extent is arranged to increase.

5. The one-way clutch of claim 1 wherein a one of said first and second races further comprises at least one axial protrusion, wherein said blocking element is arranged to lockingly engage with said at least one protrusion for said relative rotation in said first direction, and wherein for said relative motion in said second rotational direction, said blocking element is arranged to slidingly engage consecutive protrusions from among said at least one protrusion.

6. The one-way clutch of claim 5 wherein said at least one axial protrusion comprises at least one ramp.

7. The one-way clutch of claim 5 wherein said at least one axial protrusion is arranged to axially displace said blocking element as part of said sliding engagement.

8. The one-way clutch of claim 5 wherein said blocking element is arranged to flex when said blocking element lockingly engages said at least one protrusion, said flexing to dissipate energy associated with said locking engagement.

9. The one-way clutch of claim 5 wherein an other of said first and second races comprises at least one recess and said blocking element comprises at least one segment disposed in said at least one recess and rotationally connecting said other of said first and second races and said blocking element.

10. The one-way clutch of claim 1 wherein said first race is rotationally fixed with respect to said axis.

11. The one-way clutch of claim 1 wherein said first race is rotatable with respect to said axis.

12. The one-way clutch of claim 1 wherein said second race is rotationally fixed with respect to said axis.

13. The one-way clutch of claim 1 wherein said second race is rotatable with respect to said axis.

14. The one-way clutch of claim 1 wherein said first race is arranged for connection to said torque transmitting element.

15. The one-way clutch of claim 1 wherein said second race is arranged for connection to said torque transmitting element.

16. The one-way clutch of claim 1 wherein said clutch is arranged for use in a stator of a torque converter.

17. A one-way clutch comprising:
a first race circumferentially disposed about an axis for said clutch;
a second race circumferentially disposed about said axis; and,
a blocking element formed from wire having at least one segment, wherein one of said first or second races is arranged for connection to a torque transmitting element in an automotive device, wherein one of said first or second races comprises a recess and said at least one segment is disposed in said at least one recess to rotationally connect said one of said first and second races and said blocking element, wherein another of said first or second races comprises at least one ramp, wherein said blocking element is arranged to engage said at least one ramp to rotationally lock said first and second races for relative rotation of the first or second race, connected to the torque transmitting element, with respect to the other of the first or second races in a first rotational direction, and wherein the first or second race, connected to the torque transmitting element, is arranged to rotate independently of the other of the first or second races for rotation, with respect to the other of the first or second races, in a second rotational direction, opposite said first rotational direction.

18. A stator one-way clutch comprising:
a hub;
an outer element arranged for connection to a blade assembly for said stator; and,
a blocking element, wherein said blocking element is formed from wire and is arranged to rotationally lock said hub and said outer element for rotation of said outer element in a first rotational direction.

19. The stator one-way clutch of claim 18 wherein a circumferential extent of said blocking element in contact with said hub and said outer element is greater than an axial extent of said blocking element in contact with said hub and said outer element.

20. The stator one-way clutch of claim 18 wherein one of said hub and said outer element further comprises at least one axial protrusion, wherein said blocking element is arranged to lockingly engage with said at least one protrusion for said rotation in said first direction, and wherein for rotation of said outer element in a second rotational direction, opposite said first rotational direction, said blocking element is arranged to slidingly engage consecutive protrusions from among said at least one protrusion.

21. The stator one-way clutch of claim 20 wherein said at least one axial protrusion comprises at least one ramp.

22. The stator one-way clutch of claim 20 wherein said blocking element is arranged to flex when said blocking element lockingly engages said at least one protrusion, said flexing to dissipate energy associated with said locking engagement.

23. The stator one-way clutch of claim 18 wherein one of said hub and said outer element comprises at least one recess and said blocking element comprises at least one segment disposed in said at least one recess and rotationally connecting said one of said hub and said blocking element.

24. A stator one-way clutch comprising:
a hub;
an outer element arranged for connection to a blade assembly for said stator;
a blocking element formed from wire having at least one segment, wherein one of said hub and said outer element comprises a recess and said at least one segment is disposed in said at least one recess to rotationally connect said one of said hub and said outer element, wherein an other of said hub and said outer element comprises at least one ramp and said blocking element is arranged to lockingly engage said at least one ramp, to rotationally lock said hub and said outer element for rotation of said outer element in a first direction, and wherein for rotation of said outer element in a second direction, opposite said first direction, said blocking element is arranged to slidingly engage consecutive ramps from among said at least one ramp.
